(19) United States
(12) Patent Application Publication
(10) Pub. No.: US 2002/0162693 A1
(43) Pub. Date: Nov. 7, 2002

(54) Vehicle with fuel cell system configured to effectively utilize generated heat

(76) Inventors: Yutaka Mizuno, Iwata (JP); Masahisa Kuranishi, Iwata (JP)

Correspondence Address: KNOBBE MARTENS OLSON & BEAR LLP, 2040 MAIN STREET, FOURTEENTH FLOOR, IRVINE, CA, 91614, US

(21) Appl. No.: 09/846,895

(22) Filed: May 1, 2001

(51) Int. Cl. B60K 1/00

(52) U.S. Cl. 180/65.1

(57) ABSTRACT

A fuel cell system for powering a vehicle effectively utilizes heat generated by various components of the system. A fuel cell produces electrical power by combining hydrogen and oxygen to form a water by-product. The electrical power is used to charge a battery, which in turn, is used to power an electric motor controlled by a motor driver. The battery, the motor, and the motor driver generate heat, which is captured by water brought in thermal contact with these heat-generating components. The heat-generating components can be immersed in water tanks or surrounded by water jackets to effect the heat transfer to the water. The battery is used to power the motor and generate heat before the fuel cell begins operating. Water heated by the battery, motor, and/or motor driver is provided to the fuel cell in order to bring the fuel cell up to operating temperature.

### RELATED APPLICATIONS

This application is related to Japanese Patent Application 11-339736, entitled “VEHICLE WITH FUEL CELL DRIVING SYSTEM MOUNTED THEREON,” inventors Mizuno and Kuranishi, attorney docket number P16464, filed Nov. 30, 1999, which has been assigned to the assignee of the present invention and which is hereby incorporated by reference in its entirety.

### BACKGROUND OF THE INVENTION

1. Field of the Invention

The present invention relates to a vehicle powered by a fuel cell driving system and, more particularly, to a vehicle configured to effectively utilize heat generated by heat-generating devices in the fuel cell driving system.

2. Description of the Related Art

Fuel cells create electricity by combining hydrogen and oxygen to form water without combustion. Hydrogen gas can be supplied in raw form, but can alternatively be obtained from hydrogen-rich fuels (feedstock), such as methanol, using a reformer. A reformer is typically an endothermic device that transforms the feedstock into hydrogen gas and other by-products, such as CO and CO₂. The construction and use of fuel cells and reformers is conventional and well-known.

The fuel cells can be used to power electric vehicles such as cars, scooters, and motorcycles. In one configuration, the fuel cell is used to power a battery. The battery, in turn, is used to power an electric motor that propels the vehicle.

Known fuel cell configurations for fuel cell vehicles typically include assemblies to radiate or conduct heat away from the vehicle. These configurations, however, do not generally make effective use of heat generated by various components of a fuel cell system. The present invention seeks to address this deficiency, among others.

### SUMMARY OF THE INVENTION

A fuel cell system for powering a vehicle effectively utilizes heat generated by various components of the system. As noted above, a fuel cell produces electrical power by combining hydrogen and oxygen to form a water by-product. The electrical power is used to charge a battery, which in turn, is used to power an electric motor controlled by a motor driver. The battery, the motor, and the motor driver generate heat, which is absorbed by water brought into thermal contact with these heat-generating components. The heat-generating components can be immersed in water tanks or surrounded by water jackets to effect the heat transfer to the water.

In one embodiment, the battery is used to power the motor and generate heat before the fuel cell begins operating. Water heated by the battery, motor, and/or motor driver is provided to the fuel cell in order to bring the fuel cell up to operating temperature or maintain the operating temperature. Accordingly, the time needed to bring a fuel cell up to operating temperature and to activate the fuel cell can be reduced. After the fuel cell has reached operating temperature and begun operation, the temperature of the fuel cell is regulated such that it does not exceed a maximum temperature. The temperature of the fuel cell can be regulated by regulating the temperature of the water introduced into the fuel cell. The temperature of the water can be controlled through control valves that control whether the water is passed into thermal contact with the heat-generating devices.

In one embodiment, water is sequentially brought into thermal contact with two or three of the heat generating devices of increasing temperature to further heat the water before the water is provided to the fuel cell. In one embodiment, the water is first heated by a battery, then by an electric motor, then by a motor driver to increasing temperatures.

In one embodiment, water produced by the fuel cell is passed through a heat exchanger to cool water vapor and recapture liquid water before the vapor is released. The recaptured water is collected in a water tank and then supplied as humidification water to the fuel cell. The recaptured water reduces the amount of water that is lost through the exhaust of the fuel cell.

In one embodiment, heat generated by one of the heat-generating devices is used to heat fuel through a heat exchanger before the fuel is supplied to a reformer. Since the reforming process is generally endothermic, heat from the heat-generating device is effectively used.

### BRIEF DESCRIPTION OF THE DRAWINGS

FIG. 1 is a block diagram of a fuel cell driving system having certain features according to a first embodiment of the present invention.

FIG. 2 is a plan view of a scooter provided with the fuel cell driving system of FIG. 1.

FIG. 3 is a side view of a scooter provided with the fuel cell driving system of FIG. 1.

FIG. 4 is a block diagram of a fuel cell driving system having certain features according to a second embodiment of the present invention.

FIG. 5 is a side view of a scooter provided with the fuel cell driving system of FIG. 4.

FIG. 6 is a flowchart illustrating the operation of the fuel cell driving system.

FIG. 7 is a flowchart illustrating the operation of a water circulation system for the fuel cell driving system.

### DETAILED DESCRIPTION OF THE INVENTION

In the following description, reference is made to the accompanying drawings, which form a part hereof, and which show, by way of illustration, specific embodiments or processes in which the invention may be practiced. Where possible, the same reference numbers are used throughout the drawings to refer to the same or like components.

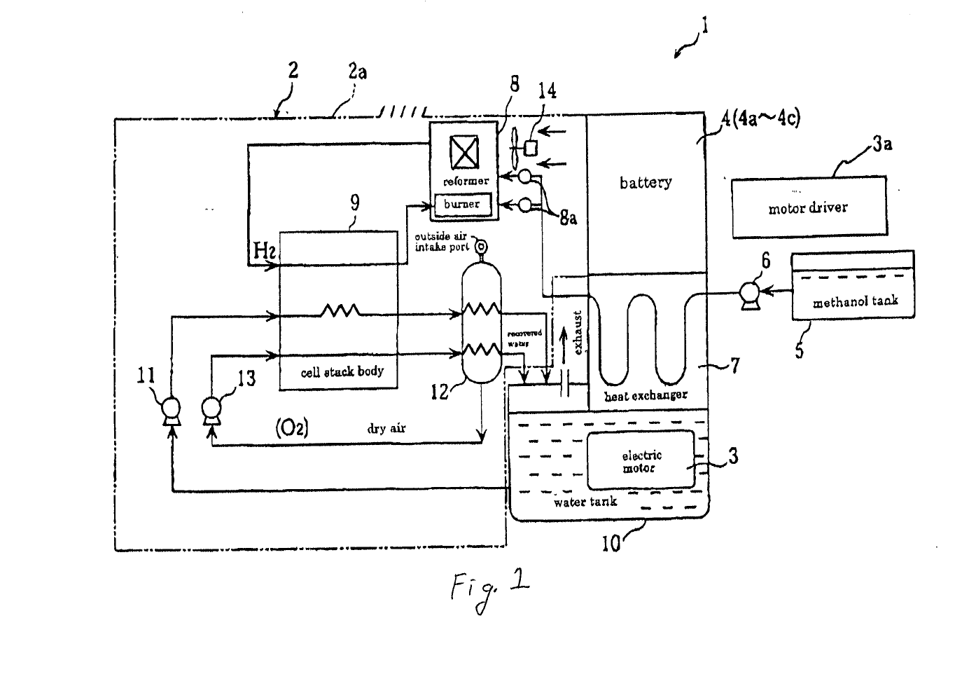

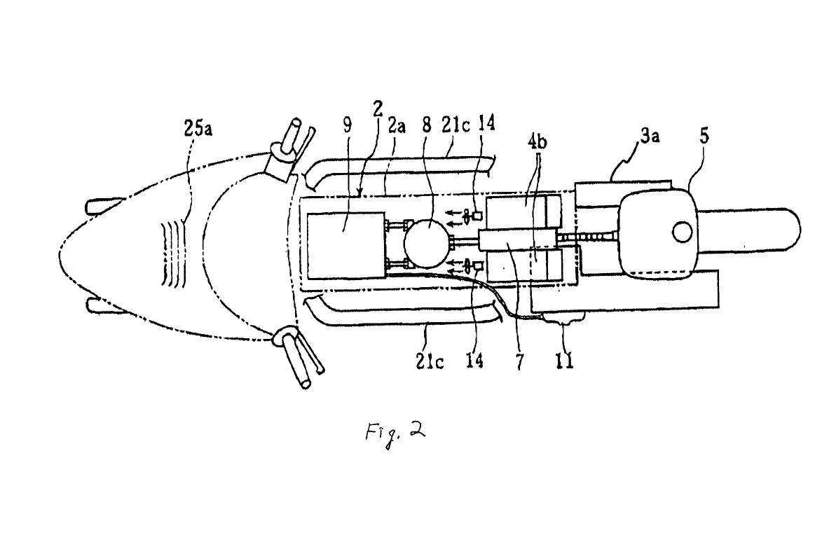

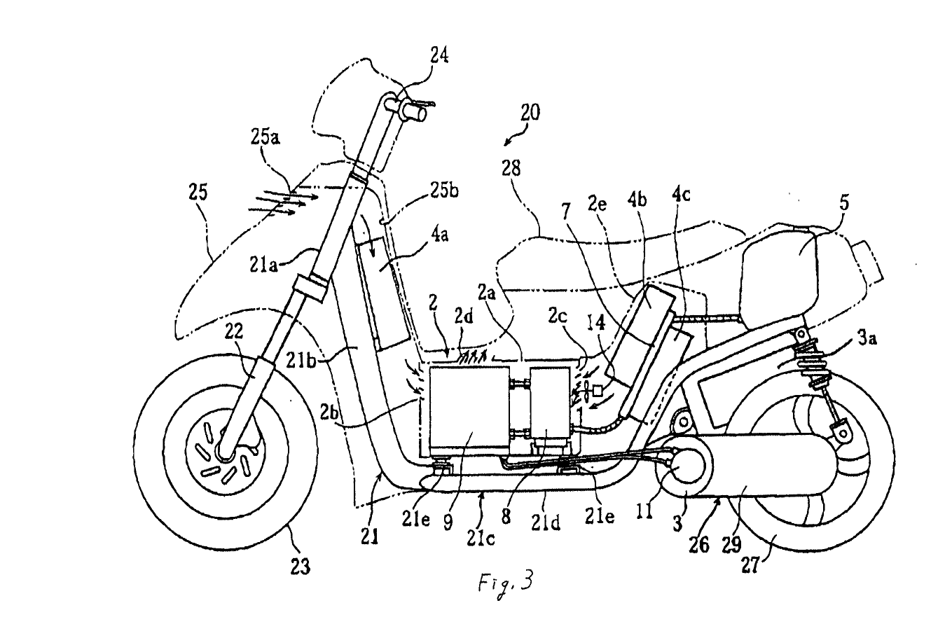

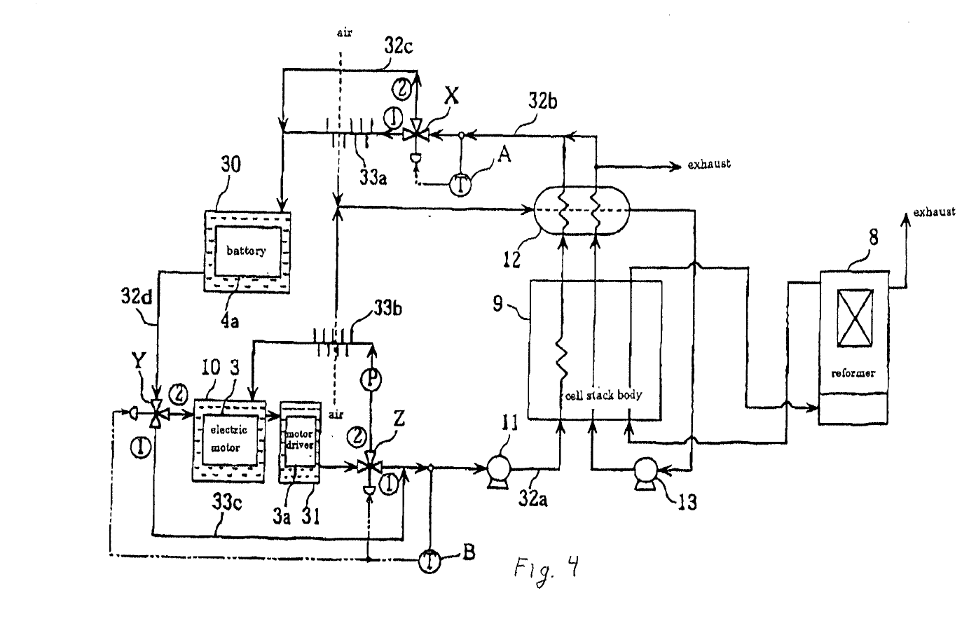

FIGS. 1 to 3 relate to a vehicle incorporating a fuel cell driving system according to a first embodiment of the present invention. FIGS. 4 to 7 relate to a vehicle incorporating a fuel cell driving system according to a second embodiment of the present invention.

FIG. 1 is a block diagram of a fuel cell driving system 1 according to a first embodiment of the invention. A fuel cell device 2 supplies electrical power for charging a battery 4, which in turn provides electrical power to an electric motor 3. The fuel cell device 2 can also provide power directly to the motor 3. The electric motor is controlled via a motor driver 3a.

A methanol tank 5 supplies methanol (feedstock) to a reformer 8 through a pump 6 with a flow rate being adjusted by an adjusting valve 8a. The methanol passes through a heat exchanger 7, which can be used to heat the methanol before it reaches the reformer. The adjusting valve 8a can be actuated by a solenoid or other actuation mechanism, which is in turn preferably controlled by a controller or control unit in order to control the generation of power by the fuel cell.

The reformer 8 produces hydrogen gas from the methanol and the hydrogen gas is supplied via a CO reducing device (not shown) to a cell stack body 9 which produces electrical power. In the reformer 8 a portion of the methanol is mixed with water. The mixture is heated by a burner to evaporate the mixture. The evaporated mixture is transformed by a catalyst to form hydrogen gas and other by-products. A portion of the methanol is also used to drive the burner. Surplus hydrogen, which is not used by the cell stack body, is preferably supplied to the burner for combustion.

In the cell stack body 9, the hydrogen gas is combined with oxygen to produce electricity and water or water vapor as a by-product. A water pump 11 supplies water from a water tank 10 for humidification of the cell stack body 9.

Additional information relating to the operation of the fuel cell is disclosed in U.S. patent application ______, titled “HYBRID-DRIVEN DEVICE,” attorney docket number YAMAH5.895APC, and filed on Apr. 26, 2001, which has been assigned to the assignee of the present invention and which is hereby incorporated by reference in its entirety.

The humidification and by-product water from the cell stack 9 are passed through a heat exchanger 12, which cools the water vapor to recapture moisture. The water and water vapor enter the heat exchanger at a high temperature input and as the water and water vapor are cooled, water vapor is recaptured as liquid. The liquid is output at low temperature output of the heat exchanger 12. A fan 13 sucks intake air through the heat exchanger 12 from a low temperature input to a high temperature output in order to effect the cooling. The intake air is heated and dried by the heating effect since as air is heated, its relative humidity decreases. The heated intake air is passed into the cell stack body 9 to provide oxygen for the electricity generating reaction.

In one embodiment, water output from the low temperature output of the heat exchanger 12 is supplied to a low temperature input of the water tank 10. The water tank 10 heats the water and supplies the heated water through a high temperature output to the cell stack body 9 as humidification water. The water tank 10 can include water channels and/or passageways that transfer heat from a heat generating device to the water. The heat generating device can be, for example, the motor 3, the motor driver 3a or the battery 4. Accordingly, the water tank 10 can act as a heat exchanger transferring heat from the heat generating device to the water. The water channels and/or passageways can include, for example, a water jacket through which heat is absorbed from the motor 3. The heated water can also be used to heat the reformer 8.

FIGS. 2 and 3 illustrate a schematic plan view and a side view, respectively, of a vehicle 20 powered by the fuel cell driving system 1. In the illustrated embodiments, the vehicle is a scooter or motorcycle, but the vehicle can be another type of vehicle, such as a car, truck, ATV, golf cart or “community” car.

With reference to FIG. 3, the scooter 20 has a body frame 21 including a head pipe 21a at the front end, a main pipe 21b extending rearward and downward from the head pipe 21a. A pair of side pipes 21c and 21c are connected to a lower end of the main pipe 21b, generally horizontally extending rearward forming low-floor foot rests 21d and extending rearward and upward.

A front fork 22 is steerably supported by the head pipe 21. A front wheel 23 is rotatably supported at the lower end of the front fork 22, to which a steering handle 24 is secured at the upper end thereof. A seat 28 is mounted above the side pipes 21c. A body cover 25 surrounds the front fork 22 and covers the right and the left sides of the body frame 21.

A unit swing type motor unit 26 is pivotably mounted at its forward end to a rearward and upward extended portion of the side pipes 21c. A rear wheel 27 is rotatably supported at the rear end of the motor unit 26. The motor can directly drive the wheel or a transmission can be used to transfer motor power to the wheel. The motor unit 26 is a combination of the motor 3, which is preferably transversely mounted, and a transmission case 29 extending rearward along a side of the vehicle. The motor 3 is a water-cooled type surrounded by a water jacket, which preferably functions as the water tank 10.

The reformer 8 and the cell stack body 9 are preferably accommodated in a casing 2a mounted on supporting frames 21e and 21d laid between footrests 21d and 21d on both right and left sides of the body frame 21. The casing 2a is preferably mounted for easy removal for repair and/or replacement, such as, in a “drop-out” configuration in which the casing can be removed from the bottom of the vehicle. The casing 2a has an air introduction port 2b in the front wall thereof for receiving air forced in from vehicle motion, an air supply port 2c in the rear wall thereof, and an air exhaust port 2d in the top wall thereof.

The battery 4 is preferably divided into six parts; two front batteries 4a, two upper batteries 4b, and two lower batteries 4c. The front batteries 4a are disposed in an air introduction duct 25b through which air is forced by vehicle motion into an air intake 25a of the body cover 25. The forced air is then supplied through the duct 25b into the casing 2a. The upper and lower batteries 4b and 4c are disposed on a rising part 21f at the rear of the body frame 21. The heat exchanger 7 is preferably interposed between the upper batteries 4b and between lower batteries 4c.

Cooling fans 14 disposed at the air supply port 2c supply cooling air into the casing 2a. The cooling fans 14 suck air around the upper and lower batteries 4b and 4c and push the air through the cooling air supply port 2c into the casing 2a. The upper and lower batteries 4b and 4c, the heat exchanger 7 and the cooling fans 14 are surrounded by a rearward extended portion 2e of the casing 2a.

In the scooter 20 of this embodiment, the fuel cell device 2 is preferably not activated when the vehicle starts running. Thus, at first, electric power is supplied from the batteries 4a, 4b, and 4c to the electric motor 3, by which the rear wheel is driven and the vehicle runs. Methanol, which absorbs heat from the upper and lower batteries 4b and 4c while passing from the methanol tank 5 through the heat exchanger 7, is supplied to the reformer 8. Hydrogen gas produced by the reformer 8 is supplied to the cell stack body 9. Outside air sucked by the blowing fan 13 (FIG. 1) is dried while passing through the heat exchanger 12 (FIG. 1) and is then provided to the cell stack body 9. The heat exchanger 12 also recaptures water vapor produced by the cell stack body 9 (as illustrated in FIG. 1). Water warmed by the heat generated by the motor 3 in the water tank 10 is also supplied to the cell stack body 9 by the pump 11 for humidifying water. Water passing through the cell stack body 9 is returned to the water tank 10.

The outside air sucked by the cooling fans 14 cools the upper and lower batteries 4b and 4c, and the air whose temperature has been raised by this cooling is supplied to the burner of the heater of the reformer 8. After the fuel cell device 2 has met conditions required for activation, electric power generated by the fuel cell device 2 is supplied to the electric motor 3.

In one embodiment, the electric motor 3 is cooled by a cooling system, which includes the water tank 10 within which the motor 3 is disposed. Fuel cells typically must be raised to an operating temperature (e.g. 80 degreed Celsius) in order to be activated. The time needed to activate the fuel cell device 2 can be shortened since water supplied to the cell stack body 9 is warmed by heat generated by the motor 3. Since fuel supplied to the reformer 8 is warmed by heat from the batteries 4b and 4c, the amount of heat required to be generated by the burner is reduced.

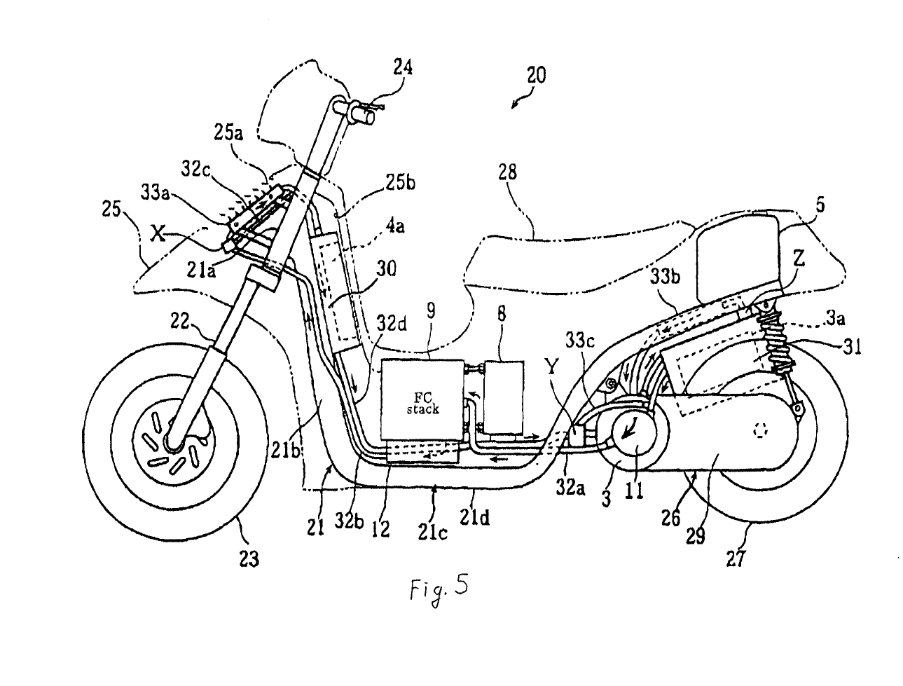

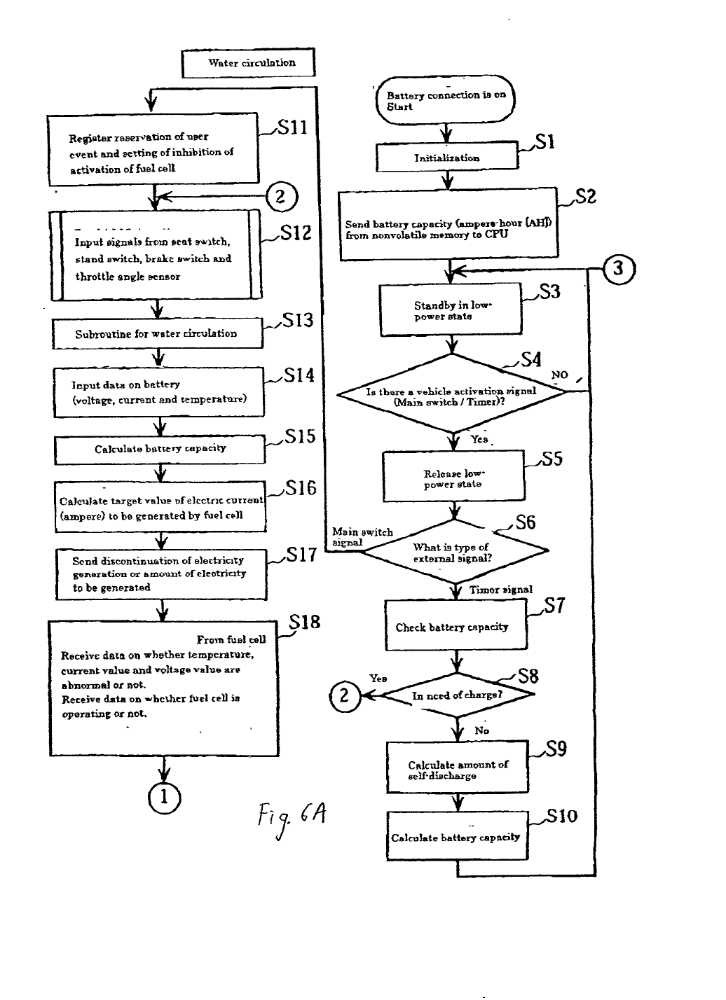

FIG. 4 is a block diagram of a system according to a second embodiment. FIG. 5 illustrates a schematic of a vehicle 20 powered by the system according to the second embodiment.

In this embodiment, the battery 4, the electric motor 3 and the motor driver 3a are accommodated in a battery water tank 30, a motor water tank (a water cooling jacket) 10, and a motor driver water tank 31, respectively. Alternatively, water passageways or heat exchangers can be used instead of water tanks. The water passageways or heat exchangers can be configured to receive heat from the battery 4, the motor 3, and the driver 3a.

The battery water tank 30 is disposed in an air introduction duct 25b formed in the body cover 25. The cell stack body 9 and the reformer 8 are preferably contained in a single unit and mounted on or adjacent to the footrests 21d. Air warmed by heat from the battery water tank 30 is passed around the cell stack body 9 and the reformer 8.

The water pump 11 is attached to the left side of the water tank 10 portion of the motor unit 26. The water pump 11 can be driven by the motor. The driver water tank 31 is disposed on the right side of the rear wheel 27. A radiator 33b is disposed above the rear wheel 27.

Water discharged from the water pump 11 is supplied through a water supply passageway 32a to the cell stack body 9. From the cell stack body 9 the water is passed through the heat exchanger 12 and through water supply passageways 32b and 32c. The water is then passed into the battery water tank 30. The water is then passed through a water supply passageway 32d, to the motor water tank 10, and to the driver water tank 31. The water is then returned to the water pump 11.

The water supply passageway 32a is preferably disposed along the foot rests 21d of the body frame 21. The water supply passageways 32b and 32c are preferably disposed along the main pipe 21b of the body frame 21.

A radiator 33a is disposed at the air intake 25a in the body frame 25 and is connected to the water supply passageway 32c. Air is heated as it is passed through the radiator 33a and the water tank 30. A bypass in the water supply passageway 32c allows water to be diverted to bypass the radiator 33a. A three-way valve X, having first and second outlets, is disposed in the water supply passageway 32c at the branch point upstream of the radiator 33. A temperature sensor A is disposed on the upstream side of the three-way valve X and the opening direction of the three-way valve X is controlled on the basis of a temperature detected by the water temperature sensor A.

A bypass passageway 33c is connected to bypass the motor water tank 10 and the driver water tank 31, and a three-way valve Y is disposed at the upstream branch point of the bypass passageway 33c. The downstream side of the driver water tank 31 is connected to a three-way valve Z disposed at a branch point downstream of the driver water tank 31. A first outlet of the valve Z passes water to the cell stack body 9 and a second outlet passes water to a radiator 33b and then back to the motor water tank 10.

A temperature sensor B is disposed downstream of the downstream branch point of the bypass passageway 33c between the valve Z and the cell stack body 9. The opening directions of the three-way valves Y and Z are controlled on the basis of a temperature detected by the temperature sensor B.

In this embodiment, water discharged from the pump 11 is switched to the water supply passageway 32c when a temperature detected by the temperature sensor A is a predetermined temperature or lower, and to the radiator 33a when the temperature is higher the predetermined temperature by the three-way valve X. Water having passed through the battery water tank 30 is switched to the bypass passageway 33c when a temperature detected by the temperature sensor B is a predetermined temperature or higher, and to the motor water tank 10 and the driver water tank 31 when the temperature is lower than the predetermined temperature by the three-way valve Y. When water is passing through the bypass passageway 33c, water in the motor water tank 10 and the driver water tank 31 is circulated through the radiator 33 by the three-way valve Z.

Though not shown, there may be provided a bypass passageway bypassing the battery water tank, a three-way valve at the upstream branch point thereof and a temperature sensor at the downstream thereof so that water may pass through the bypass passageway when a temperature detected by the temperature sensor is a predetermined temperature or higher.

Though not shown, the vehicle preferably includes one or more control units or controllers configured to control the operation of the fuel cell 9; the reformer 8; the pumps 11, 13; valves X, Y, and Z; and possibly other components. A control unit can be embodied as a hard-wired circuit, a dedicated processor, or a specially programmed general purpose computer. In one embodiment the vehicle is equipped with a fuel cell controller for controlling the fuel cell device 2, and a vehicle controller for controlling the electric motor 3.

Though not shown, the vehicle preferably includes one or more control units or controllers configured to control the operation of the fuel cell 9; the reformer 8; the pumps 11, 13; valves X, Y, and Z; and possibly other components. A control unit can be embodied as a hard-wired circuit, a dedicated processor, or a specially programmed general purpose computer. In one embodiment the vehicle is equipped with a fuel cell controller for controlling the fuel cell device 2, and a vehicle controller for controlling the electric motor 3. In one embodiment, and the control operation described below is executed while necessary data are sent and received between both controllers.

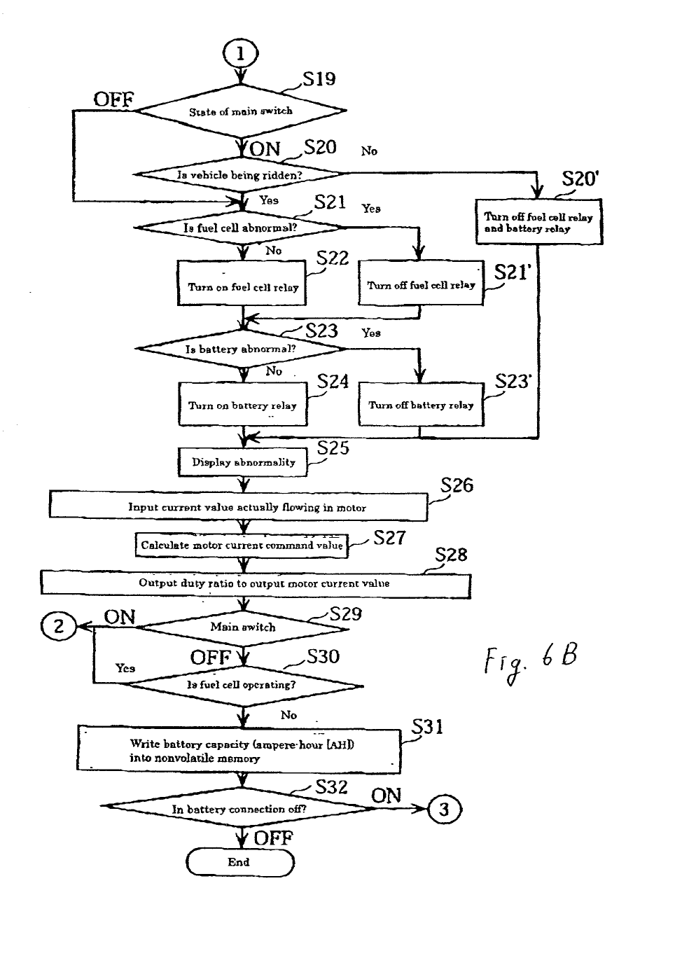

FIG. 6 illustrates a flowchart of a method performed in accordance with the second embodiment.

At steps S1, S2, and S3, when the control flow starts, various abnormality flags and numeric values are initialized, the battery capacity (ampere-hour [AH]) at the moment is read from an on-board nonvolatile memory, and the system is brought into a low-power standby state. A low-power state here is a state in which a low power necessary to ensure a standby state of the control is applied.

At step S4, the presence or absence of a vehicle activation signal (a main switch, on-off signal, a timer signal, etc.) is determined. When there is no signal, the low-power standby state is continued, and when there is a signal, the low-power state is released at step S5. The timer signal can be an activation signal to activate the fuel cell device 2 to fully charge the battery for the next run while the vehicle is not running.

When the vehicle activation signal is a timer signal, the battery capacity is detected at step S7. When the battery is determined not to be in need of charge, an amount of self-discharge thereof is calculated at steps S8, S9, and S10, and the process goes back to step S3. When the vehicle activation signal is a signal representing that the main switch is turned on, various registrations, such as a reservation of a user event and a setting of inhibition of activation of the fuel cell device 2 are executed at step S11.

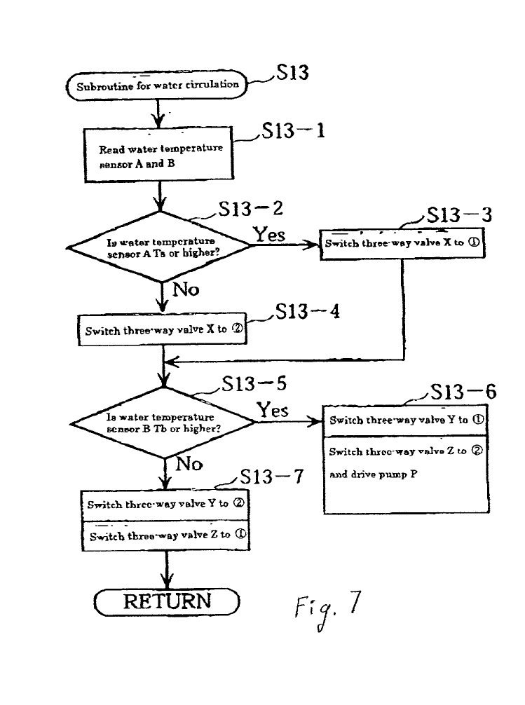

When the battery is determined to be in need of charge, the process goes to step S12. At steps S12 and S13, signals from a seat switch, a stand switch, a brake switch, throttle angle sensor and so on are read, and a subroutine for water circulation (described below with reference to FIG. 7) is executed on the basis of the detected values. These switches can be used to indicate that an operator is present. Data on the battery (voltage, current, temperature) are read to calculate the battery capacity, and the optimum target value of electric current to be generated according to the temperature of the battery.

At steps S16, S17, and S18 an indication of the amount of electricity to be generated is sent to the fuel cell device side while data on presence or absence of abnormality in temperature, current value, voltage value etc., on whether the fuel cell device is operating or not, and so on are received from the fuel cell device side.

At step S19, the state of the main switch is determined. When the main switch is on, whether the vehicle is being ridden or not is determined on the basis of the detection results of the seat switch, the stand switch and the brake switch in steps S12 and S20. When the vehicle is being ridden, the presence or absence of an abnormality in the fuel cell device 2 is determined on the basis of detection result in step S18. When there is no abnormality, a relay of the fuel cell device is turned on at steps S21 and S22). Also, the presence or absence of an abnormality in the battery is determined on the basis of the detection result in step S14. When no abnormality is in the battery, a battery relay is turned on and an abnormality displaying process is executed at steps S23, S24, and S25.

When the vehicle is not being ridden in step S20 both the relays of the battery and the fuel cell device are turned off at step S20′. When there is an abnormality in the fuel cell device 2 in step S21, the relay of the fuel cell device is turned off at step S21′. When there is an abnormality in the battery in step S23, the battery relay is turned off at step S23′.

At step S26, S27, and S28, a current value actually flowing in the motor is inputted, a motor current command value is calculated on the basis of the inputted current value and the throttle angle value detected in step S12 etc., and a duty ratio for outputting the motor current value is outputted.

At step S29, when the main switch is on, or when the main switch is off and the fuel cell device 2 is operating, the process goes to step S12. On the other hand, when the main switch is off and the fuel cell device has been stopped at step S30, the value of the battery capacity is written into the non-volatile memory at step S31. When the battery is in connected state, the process goes back to step S3, and when the battery is not in connected state at step S32, the process is terminated.

FIG. 7 illustrates a subroutine for water circulation. At step S13-1 temperatures are detected by the temperature sensors A and B. At steps S13-2 and S13-3, when the temperature detected by the temperature sensor A disposed upstream of the battery water tank 30 is a predetermined temperature Ta (80° C., for example) or higher, a first outlet of the three-way valve X is opened so that water is supplied to the battery water tank 30 after having radiated heat in the radiator 33a. When the temperature detected by the temperature sensor A is not a predetermined temperature Ta or higher, a second outlet of the three-way valve X is opened so that water is directly supplied to the battery water tank 30 at step S13-4.

At step S13-5, when a temperature detected by the temperature sensor B is a predetermined temperature Tb (90° C., for example) or higher, a first outlet of the three-way valve Y and a second outlet of the three-way valve Z are opened at step S13-6 so that water having passed through the battery water tank 30 is supplied through the bypass passageway 33c to the cell stack body 9 without passing through the water tanks 10 and 31. In this case, water in the motor water tank 10 and the motor driver water tank 31 is circulated through the radiator 33b and radiates heat. On the other hand, when the temperature detected by the temperature sensor B is not the predetermined temperature Tb or higher, a second outlet of the three-way valve Y and a first outlet of the three-way valve Z are opened at step S13-7 so that water having passed through the battery water tank 30 is supplied to the cell stack body 9 after having passed through the motor water tank 10 and the driver water tank 30 and having been warmed further.

In the second embodiment, the battery water tank 30, the motor water tank 10 and the driver water tank 31 are preferably connected in series so that water can be warmed effectively using heat generated by the battery 4, electric motor 3 and the motor driver 3a, and the time needed to activate the fuel cell device 2 can be shortened by supplying the warmed water to the cell stack body 9.

The bypass passageway 33c is provided so that water may be supplied directly to the cell stack body 9 bypassing the water tanks 10 and 31 when the temperature of the water to be supplied to the cell stack body 9 is a predetermined temperature or higher. Accordingly, the temperature of the water to be supplied to the cell stack body 9 can be prevented from abnormally rising. The cell stack body 9 in this embodiment is provided with an ion-exchange resin membrane therein, and the durability of which is reduced when its temperature is a certain temperature or higher.

The water in the tanks is supplied to the cell stack body 9 and some of the water that is supplied to the cell stack body 9 and some of the water produced in the cell stack body 9 is returned to the water tanks. Accordingly, water to be supplied to the cell stack body can be secured easily.

Although the invention has been described in terms of certain embodiments, other embodiments that will be apparent to those of ordinary skill in the art, including embodiments which do not provide all of the features and advantages set forth herein, are also within the scope of this invention. Accordingly, the scope of the invention is defined by the claims that follow. In method claims, reference characters are used for convenience of description only, and do not indicate a particular order for performing a method.

What is claimed is:

1. A fuel cell driving system for a vehicle, the system comprising a fuel cell device and a first heat-generating component, said fuel cell comprising a cell stack body, a first heat exchanger cooperating with said first heat generating component and comprising a first fluid tank, fluid contained in said first fluid tank being heated by the first heat-generating component, the heated fluid being supplied from the first fluid tank to a cell stack body of a fuel cell device, and the first heat-generating component being selected from the group consisting of: a battery, a motor, and a motor driver.

2. The system of claim 1, wherein the first heat-generating component is a battery.

3. The system of claim 1, wherein the first heat-generating component is a motor and the first fluid tank is a fluid jacket surrounding the motor.

4. The system of claim 1, wherein the first heat-generating component is a motor driver.

5. The system of claim 1 further comprising a second heat-generating component disposed in a second fluid tank, the second fluid tank being disposed downstream of the first fluid tank and being fluidly connected to said first fluid tank, fluid contained in the second fluid tank being heated by the second heat-generating component, the heated fluid being supplied from the second fluid tank to the cell stack body, and the second heat-generating component being selected from the group consisting of: a battery, a motor, and a motor driver.

6. The system of claim 1 further comprising a second heat-generating component disposed in a second fluid tank, fluid contained in the second fluid tank being heated by the second heat-generating component, the heated fluid being supplied from the second fluid tank to a reformer and the second heat-generating component being selected from the group consisting of: a battery, a motor, and a motor driver.

7. The system of claim 1, wherein heated fluid is supplied from the first fluid tank to the cell stack body of the fuel cell device to provide heat to the cell stack body.

8. The system of claim 1, wherein some fluid that is supplied to the cell stack body is returned from the cell stack body to the first fluid tank.

9. The system of claim 8 further comprising a bypass passageway, the bypass passage diverting at least a portion of fluid such that the diverted portion of fluid does not flow into the first fluid tank but flows to the cell stack body.

10. A fuel cell driving system for a vehicle, the system comprising a fuel cell and a first heat generating component associated with the vehicle, the fuel cell comprising a cell stack body and a reformer, the reformer supplying fuel to the cell stack body, the first heat-generating component disposed in a first fluid tank, heat being transferred to the fluid in the first fluid tank from the first heat-generating component, the heated fluid being supplied from the first fluid tank to the reformer of the fuel cell, and the first heat-generating component being selected from the group consisting of: a battery, a motor, and a motor driver.

11. The system of claim 10 further comprising a second heat-generating component being disposed in a second fluid tank, the second fluid tank being disposed downstream of the first fluid tank, fluid contained in the second fluid tank being heated by the second heat-generating component, heated fluid being supplied from the second fluid tank to the cell stack body of the fuel cell, and the second heat-generating component being selected from the group consisting of: a battery, a motor, and a motor driver.

12. The system of claim 10, further comprising a second heat-generating component disposed in a second fluid tank, fluid contained in the second fluid tank being heated by the second heat-generating component, heated fluid being supplied from the second fluid tank to the reformer, and the second heat-generating component being selected from the group consisting of: a battery, a motor, and a motor driver.

13. The system of claim 10, wherein heated fluid is supplied from the first fluid tank to the reformer to provide heat to the reformer.

14. A fuel cell driving system for a vehicle, the system comprising a heat-generating component selected from the group consisting of: a battery, a motor, and a motor driver, a fuel cell device comprising a reformer, the reformer being in communication with a fuel supply tank, the fuel supply tank containing fuel to be transferred to the reformer and a heat exchanger configured to heat fuel that is supplied to the reformer by transferring heat from the heat-generating component to the fuel passing to the reformer.

15. The system of claim 14, wherein the heat generating component is the battery.

16. The system of claim 14, wherein the heat generating component is the motor.

17. The system of claim 14, wherein the reformer comprises a burner and the burner receives a portion of the fuel being supplied to the reformer.

18. A fuel cell driving system for a vehicle, the system comprising a motor arranged to provide movement for the vehicle, a motor driver communicating with the motor, a battery selectively supplying power to the motor, a fuel cell selectively supplying power to at least one of the motor and the battery, and a heat transfer arrangement configured to transfer heat from at least one of the motor, the motor driver, and the battery to a flow of fluid that is supplied to the fuel cell.

19. The fuel cell driving system of claim 18, wherein the heat transfer system comprises a fluid flow circuit, wherein at least one of the motor, the motor driver, and the battery is in thermal contact with the fluid flow circuit, and wherein the fuel cell is in thermal contact with the fluid flow circuit.

20. The fuel cell driving system of claim 18 further comprising a valve adapted to redirect the flow of fluid that is supplied to the fuel cell such that heat is not transferred from at least one of the motor, the motor driver, and the battery to the flow of fluid.

21. The fuel cell driving system of claim 18, wherein the fluid is water.

22. The fuel cell driving system of claim 21, wherein the water supplied to the fuel cell mixes with water generated by the fuel cell.

23. A fuel cell driving system for a vehicle, the system comprising a fuel cell that supplies power to at least one of a motor and a battery, and a heat exchanger through which fluid output from the fuel cell is passed and through which air input to the fuel cell is passed, the fluid having a higher temperature than the air such that the air is heated and the fluid is cooled within the heat exchanger.

24. The fuel cell driving system of claim 23, wherein the heat exchanger is configured to recapture fluid output from the fuel cell.

25. The fuel cell driving system of claim 24, further comprising a fluid tank configured to receive recaptured fluid output from the fuel cell.

26. The fuel cell driving system of claim 25, wherein the fluid tank is further configured to supply humidification fluid to the fuel cell.

27. A method for operating a fuel cell to drive a vehicle, the method comprising:
driving a motor with a motor driver to propel the vehicle, the vehicle comprising a battery that is adapted to store energy;
heating fluid through thermal contact with at least one of the motor, the motor driver, and the battery;
providing the heated fluid as an input to the fuel cell; and
operating the fuel cell to provide power to the battery.

28. The method of claim 27 further comprising controlling a temperature of the fluid by controlling flow through at least one heat exchanger.

29. The method of claim 28, wherein the fluid is water and the at least one heat exchanger comprises a radiator.

30. The method of claim 28, wherein the fluid is water and the at least one heat exchanger is associated with the motor.

31. The method of claim 28, wherein the fluid is water and the at least one heat exchanger is associated with the motor driver.

32. The method of claim 27 further comprising heating fuel that is supplied to a reformer by transferring heat from at least one of the motor, the motor driver, and the battery to the fuel.

33. A fuel cell driving system for a vehicle, the system comprising a fuel cell device including a cell stack body, a battery connected to the fuel cell device, a motor connected to at least one of the battery and the fuel cell device, a motor driver connected to the motor, a first heat exchanger being arranged to cooperate with the fuel cell device, and a second heat exchanger communicating with the first heat exchanger and being arranged to cooperate with at least one of the battery, the motor and the motor driver.

34. The fuel cell driving system of claim 34 additionally comprising a third heat exchanger device communicating with at least the first heat exchange device, and wherein at least another one of the battery, motor and motor drive cooperates with the third heat exchanger.

35. The fuel cell driving system of claim 34, wherein the second and third heat exchangers are arranged in series upstream of the first heat exchanger.

36. The fuel cell driving system of claim 34, wherein at least one of the first, second and third heat exchangers comprises a fluid tank.

37. The fuel cell driving system of claim 34, wherein at least one of the second and third heat exchangers comprises a cooling jacket juxtaposing one of the motor, motor driver or battery.

38. The fuel cell driving system of claim 33, wherein the first heat exchanger comprises a cooling jacket juxtaposing the cell body.

39. The fuel cell driving system of claim 33 additionally comprising a fluid circulation sub-system that circulates fluid between at least the first and second heat exchangers.

40. The fuel cell driving system of claim 39, wherein the fluid circulation sub-system and the first and second heat exchangers contain water.

41. The fuel cell driving system of claim 33 additionally comprising a third heat exchanger and a fourth heat exchanger that communicate with at least each other, the third heat exchanger arranged to cooperate with said motor and said fourth heat exchanger arranged to cooperate with said motor driver.

42. A fuel cell vehicle operating system comprising a fuel cell, a motor electrically communicating with said fuel cell, a motor controller electrically communicating with said motor, a battery electrically communicating with said fuel cell, said fuel cell comprising a cell stack body configured to receive hydrogen from a reformer, said reformer being in fluid communication with a feedstock supply tank through at least a first conduit, said reformer being in fluid communication with said cell stack body through at least a second conduit, a first heat exchanger having a high temperature input in fluid communication with said cell stack body, a second beat exchanger having a high temperature output in fluid communication with said cell stack body, a low temperature output of the first heat exchanger being in fluid communication with a low temperature input of the second heat exchanger, and an air supply for said cell stack body passing through said first heat exchanger before entering said cell stack body.

43. The system of claim 42 further comprising a cell stack body air exhaust, said cell stack body air exhaust passing through said first heat exchanger.

44. The system of claim 42 further comprising a radiator disposed along a flow path from said low temperature output of said first heat exchanger and said low temperature input of said second heat exchanger.

45. The system of claim 44 further comprising a bypass about said radiator such that at least a portion of flow through said flow path can be selectively diverted directly to said second heat exchanger without passing through said radiator.

46. The system of claim 45 further comprising a temperature dependent valve arrangement which directs flow through said bypass when a sensed temperature is below a preset temperature.

47. The system of claim 42 further comprising a third heat exchanger and a fourth heat exchanger, said first, second, third and fourth heat exchangers being arranged in series.

48. The system of claim 47, wherein a flow control valve and a first bypass, said flow control valve can divert flow through said first bypass such that at least a portion of flow through said flow control valve does not flow through said third and fourth heat exchangers.

49. The system of claim 42 further comprising a third heat exchanger, said third heat exchanger communicating with said battery and at least a portion of said first conduit forming a portion of said third heat exchanger.

50. The system of claim 42, wherein said second heat exchanger is arranged to cooperate with at least one of said motor, said motor controller and said battery.

51. The system of claim 42, wherein said second heat exchanger receives heat from at least one of said motor, said motor controller and said battery.
